(19) United States
(12) Patent Application Publication
(10) Pub. No.: US 2005/0073167 A1
(43) Pub. Date: Apr. 7, 2005

(54) Motor vehicle with improved rear functionality

(75) Inventor: Francois De Gaillard, Paris (FR)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/887,360

(22) Filed: Jul. 9, 2004

(30) Foreign Application Priority Data
Oct. 7, 2003 (DE) 103 31 421.0

(51) Int. Cl. B62D 25/10

(52) U.S. Cl. 296/76

(57) ABSTRACT

A motor vehicle, especially a sedan or a coupe, with a rear trunk and a cover means for alternately closing or clearing a top trunk opening to increase the usability of the rear area of the motor vehicle, the trunk is provided with a cover that is formed of several cover parts which are movably supported on each side of the trunk opening and in the open position can be moved forward into a storage position to clear the trunk opening. According to another approach, it is provided that a cargo box is mountable over a rear cargo space of the vehicle to provide it with an increased cargo volume by movement of a movable bottom of the cargo box from a closed position in which the cargo box is separated toward the cargo space to an open position in which the cargo box is opened toward the cargo space.

### BACKGROUND OF THE INVENTION

1. Field of the Invention

The invention relates to a motor vehicle, especially a sedan or a coupe, with a rear trunk and a cover means for alternately closing or clearing a top trunk opening.

2. Description of Related Art

DE 196 15 540 A1 discloses a passenger station wagon with an upper tailgate which pivots up and with a lower rear tailgate which pivots down. By pivoting one or both tailgates, conventionally the cargo space is accessible from the rear. A comparable passenger car is also disclosed in U.S. Pat. No. 6,227,594 B1.

### SUMMARY OF THE INVENTION

A primary object of the invention is to devise the initially specified motor vehicle with a rear area which can be used for diverse purposes due to great variability.

This object is achieved in accordance with the present invention by a motor vehicle, especially a sedan or a coupe, with a rear trunk and a cover means for alternately closing or clearing a top trunk opening, in which the cover means has several cover parts which are movably supported on either side of the trunk opening and in the open position can be moved forward into a storage position to clear the trunk opening. It is advantageous that the cover parts can be moved into their front lowered storage position so that the cargo area can be used in the manner of a pickup. This greatly increases the utility. In particular, the use of the cargo area is improved with a rear hatch which can be adjusted in diverse ways.

This object is also achieved in accordance with the present invention by a motor vehicle with a rear trunk or cargo space and a cover means for alternately closing or clearing a top trunk opening or cargo space opening, wherein an additional cargo volume is made available by means of a cargo box which is mounted over the trunk, and wherein the cargo box has a movable bottom that can be moved between a closed position in which the cargo box is separated toward the trunk, and an open position in which the cargo box is opened toward the trunk when the top trunk opening has been cleared. In this case, it is advantageous that, by means of the cargo box, an additional cargo volume can be provided, this assuming a motor vehicle which has a corresponding top clearable opening in the body. The cargo box can be adapted to different motor vehicles or can be easily adaptable by means of an adapter. The provision of an additional useful volume represents a major advantage. Possible uses are increased by the floor being movable.

These and other features of the invention are described in greater detail below with reference to the accompanying drawings.

### BRIEF DESCRIPTION OF THE DRAWINGS

FIG. 1 is a perspective view of a rear part of passenger car with the trunk cover partially opened;

FIG. 2 is a view similar to that of FIG. 1, but with the trunk cover of the passenger car opened and with the rear hatch swung vertically down;

FIG. 3 is a view similar to that of FIG. 1, but with the trunk cover opened and a rear hatch which has been swung out horizontally and which is bearing cargo;

FIG. 4 is a view similar to that of FIG. 3, but with the trunk cover opened and the swung-out rear hatch lowered;

FIG. 5 is a schematic side view of a the motor vehicle rear with a bearing means for the rear hatch in different positions of movement;

FIG. 6 is a perspective view of a rear part of passenger car with the trunk cover opened and having fold-down seats shown in their operating position with passengers;

FIG. 7 a view similar to that of FIG. 6 but depicting conversion of the trunk;

FIG. 8 is a perspective rear view of a passenger car with a liftback (station wagon) with a cargo box;

FIG. 9 the passenger car with a liftback (station wagon) of FIG. 8 with the cargo box open;

FIG. 10 is a perspective top view a cargo box for the motor vehicle of FIG. 8;

FIG. 11 shows in a side view the rear of a motor vehicle with a cargo box which is attached to it, the movable bottom of the cargo box being closed; and

FIG. 12 is a view similar to that of FIG. 11, but with the movable bottom of the cargo box open.

### DETAILED DESCRIPTION OF THE INVENTION

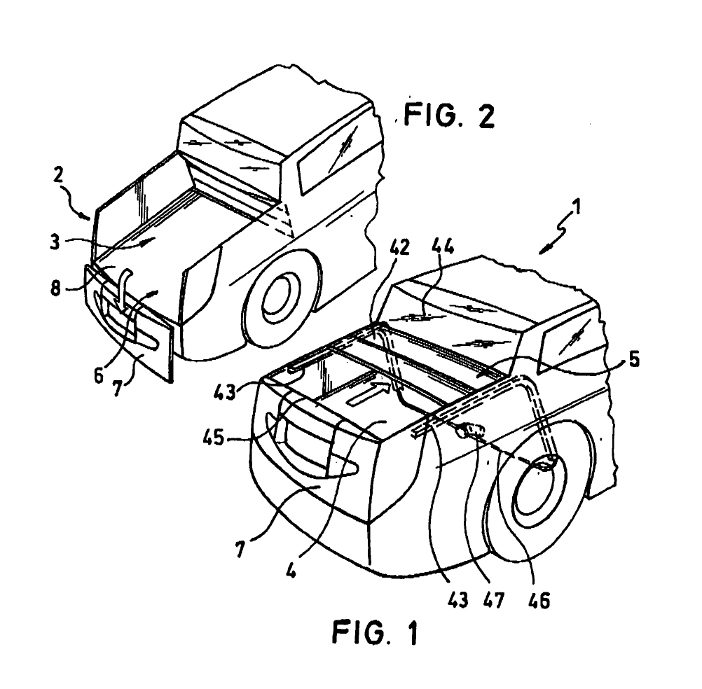

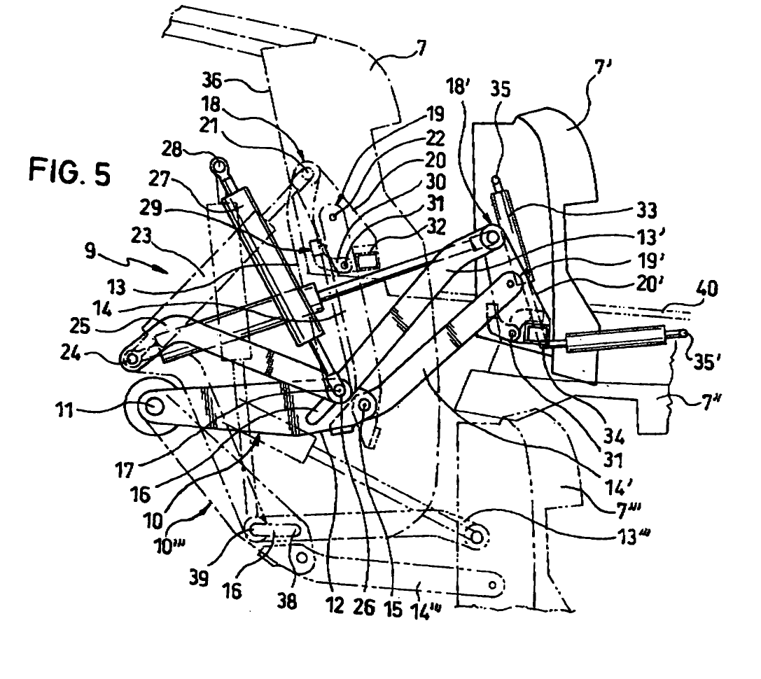

A passenger car 1, for example, in the manner of a sedan (see FIGS. 1 to 4), has a rear 2 with a cargo space or trunk 3 with a top trunk opening 4 which can be closed and at least partially cleared by a cover means 5. A rear trunk opening 6 can be closed by means of a movable rear hatch 7 which extends roughly as far as the cargo area or the floor 8 of the trunk space 3 and in the closed position is oriented essentially vertically or relative to vertical. The rear hatch 7 is movably supported on the vehicle rear 2 by a bearing means 9 (FIGS. 4 and 5) which is located on the side walls of the vehicle at each side of the rear trunk opening 6, the bearing means 9 having a respective main bearing arm 10 at each side which is supported to pivot around a pivot axis 11 on the body and extends rearward from the pivot axis 11 in the closed position of the rear hatch 7. On a rear section 12 of the main bearing arm 10 which is opposite the pivoting axis 11, a first connecting rod 13 and a second connecting rod 14 of a four-bar mechanism are pivotally supported, the second connecting rod 14 being supported by means of a pivot axle 15 which is fixed on the main bearing arm 10 and the first connecting rod 13 is supported in an oblong hole 16 which is formed in the main bearing arm 10 and its pivot bearing or its pivoting axle 17 can execute an equalization movement in the pivoting motion which is described below. The opposite ends 18, 19 of the two connecting rods 13, 14 are coupled on the carrier part 20 of the rear hatch 7 in the pivot bearings 21, 22.

A first hydraulic cylinder 23 is, on the one hand, attached to the body around the pivot axle 24, which is spaced apart from the pivoting axle 11 of the main bearing arm 10, and on the other hand, on the carrier part 20 of the rear hatch 7, coaxially relative to the pivot axle of the pivot bearing 21. The control arm 25, on the one hand, is pivotally supported on the body coaxially with respect to the pivot axle 24 of the first hydraulic cylinder 23, and on the other hand, is held so as to be able to move and pivot with the bearing journal 26 in the oblong hole 16 of the main bearing arm 10, the bearing journal 26 forming at the same time the pivot bearing of the first connecting rod 13 in the oblong hole 16 and being located coaxially relative to its pivoting axle 17.

A second hydraulic cylinder 27 is coupled to the body, on the one hand, to be able to pivot around a pivoting axle 28 which is located above the main bearing arm 10, and on the other hand, to the bearing journal 26.

A special section pipe length 29 which is permanently attached to the rear hatch 7, i.e., the end piece of a pipe which runs over the width of the rear hatch 7, is permanently connected to the pivot arm 30 which is coupled by means of a pivot joint which has a pivoting axle 31 to the carrier part 20 of the rear hatch 7 so that the rear hatch 7 can be pivoted to the rear out of its upright position. In the pivoting position of the rear hatch 7 which is, for example, manually pivoted the special section pipe length 29 adjoins the special section pipe length 32 which is permanently attached to the carrier part 20 and which is, for example, the end piece of a carrier pipe which runs over the width of the rear hatch 7 and which connects the two lateral opposite carrier parts 20 to one another.

Preferably, to pivot the rear hatch 7 out of its upright position into its horizontal position, there is a pivoting drive, for example, a hydraulic cylinder 33 which is coupled, on the one hand, to the carrier part 20 by a pivot axle 34 which is spaced apart from the pivoting axle 31, and on the other hand, to the rear hatch 7 by means of a hinged joint 35 (shown schematically).

To open the rear hatch out 7 of its closed position (see FIGS. 1 and 5), first the first hydraulic cylinder 23 is actuated so that it is lengthened by extending its piston. In doing so, it pivots the two connecting rods 13, 14 of the four-bar mechanism to the rear so that the rear hatch is moved to the rear roughly in a parallel displacement (in FIG. 5, the intermediate positions of the rear hatch 7′ and the connecting rods 13′, 14′ are shown). From this intermediate position (rear hatch 7), by actuating the third hydraulic cylinder 33, the rear hatch 7 can be moved to the rear into a horizontal position (position 7″) so that cargo 37 or baggage can be positioned on the inside 36 of the rear hatch 7.

The rear hatch 7 can be moved down out of its folded-out position 7″ as well as out of its folded-up position 7′ or an intermediate position by actuating the first and the second main cylinder 23, 27. In doing so, in addition, the main bearing arm 10 is pivoted down by the extending second main cylinder 27 (position 10′″). The control arm 25 as a result of its pivoting axle 24 which is eccentric to the pivoting axle 11 of the main bearing arm 10 pivots such that its bearing journal 26 is displaced from the back end 38 of the oblong hole 16 to its front end 39, by which the first connecting rod 13 of the four-bar mechanism is displaced to the front during its pivoting with its pivoting axle 17. This control results in the rear hatch 7 can be displaced down in its roughly vertical position 7′ or the horizontal position 7″. The rear hatch 7 can be pivoted out into its horizontal position by actuating the third hydraulic cylinder 33 in each pivoting-out position of the four-bar mechanism.

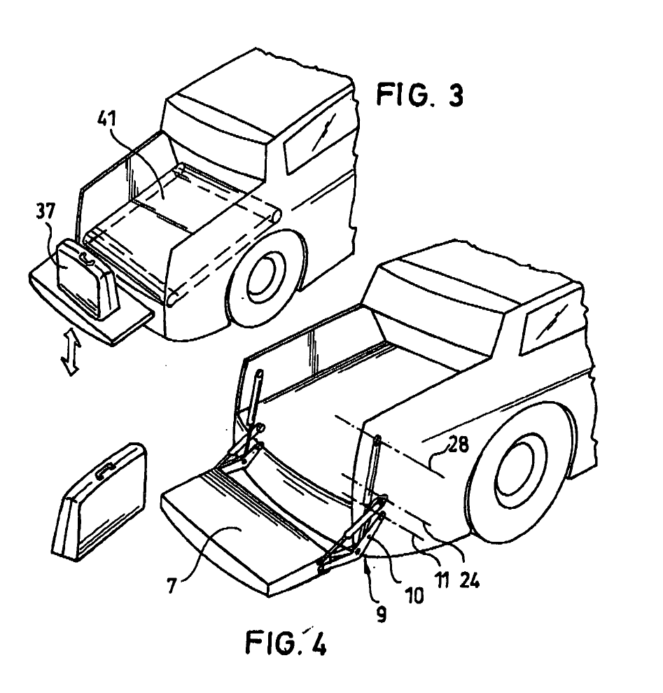

The trunk 3 can have a movably supported cargo bottom 40 (FIG. 5) which, for example, can be extended over the rear hatch 7 when the rear hatch 7 has been pivoted and folded down (for example, position 7″). Furthermore, it can be provided that the cargo bottom 40 or at least the front separable part can be located on the inside 36 of the folded-out rear hatch 7. To accommodate the cargo bottom 40, the rear hatch 7 has guides or the like. Instead of the fixed, plate-shaped cargo bottom a peripheral support structure such as, for example, a conveyor belt 41 (see, FIG. 3) can form the movable cargo bottom.

The cover means 5 contains louvers which are movably supported on two guide rails 43 which are located on the side walls of the vehicle on either side of the upper trunk opening 4 and run down towards its front end in the area underneath the rear window 44 or the package tray, for example, behind the backs of the seats or the back seats of the vehicle. The louvers 42 are connected to one another with a pivoting capacity so that they can be moved as a flat unit between their closed position in which they border the top edge 45 of the closed rear hatch 7, via any intermediate positions forward into their open position or storage position behind the back seats, in which they clear the upper trunk space opening 4. The louvers 42 are built, for example, as described in the German patent application 103 20 538.1, and are connected to one another by means of a flexible structure such as, for example, a film which assumes the sealing function between the louvers 42. A driving means for the cover means 5 and the louvers 42 on each guide rail 43 contains a drive cable 46 which is connected at least to the frontmost louver 42, and a central drive motor 47, by which the two drive cables 46 can be driven or moved. Between the front sections of the guide rails 43, which sections run linearly or slightly curved downward, thus a holding space for the louvers 42 in their open position is defined. Since the guide rails 43 are only slightly curved, louvers which are wider in the lengthwise direction of the motor vehicle can be used which could not be used in this width in the storage position which is wound in the manner of a shade.

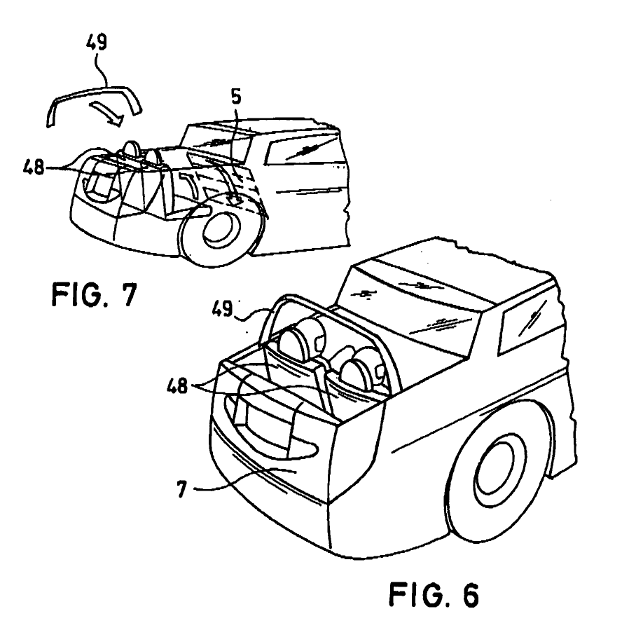

According to one embodiment, in the trunk 3 of the motor vehicle, two seats 48 (FIGS. 6 and 7) can be positioned next to one another in the position of use. The two seats 48 are, for example, arranged countersunk at least partially in or on the floor of the trunk and are extended or folded out if necessary, so that they can be used with the cover means 5 opened. To protect passengers on the seats, a roll-over protection means, for example, a roll bar 49, can be fixed on the vehicle in a protective position which traverses or rises above the passengers. The roll-over protection means or the roll bar 49 is carried at the same time, for example, in the trunk of the vehicle, and if necessary, is attached to the rear side walls of the vehicle, for example, in tubular holders. In one alternative configuration, the roll bar 49 is pivotally supported on the vehicle and is pivoted out of the lowered rest position into the active protective position. The roll bar 49 can also be located in a rest position on the periphery of the rear window 44 and can be extended to the rear into its active position by means of a sliding guide. The trunk 3 can thus be used for carrying passengers when the cover means 5 is opened. Access is gained for, example, when the rear hatch 7 has been opened. The roll-over protection means offers the passengers the required safety.

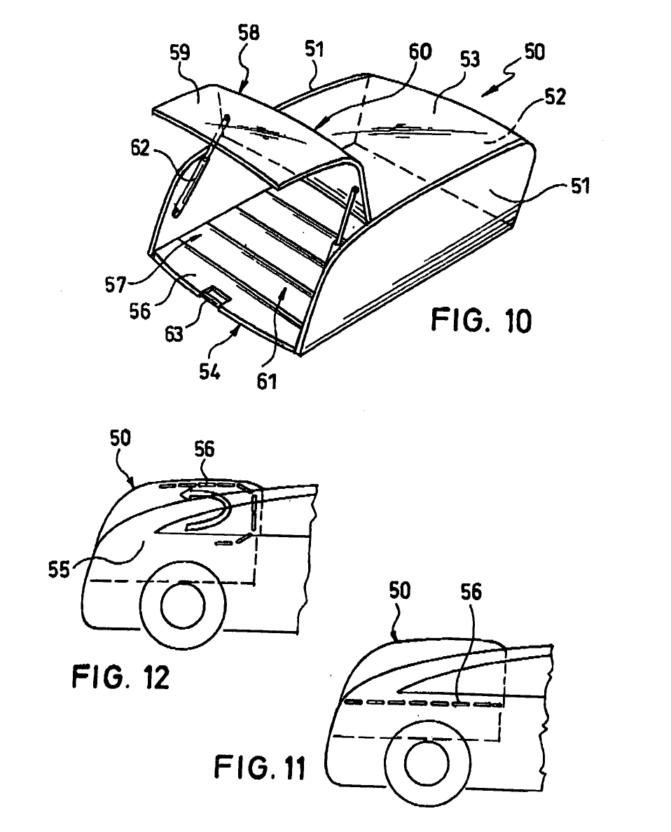

According to another embodiment of the invention, the motor vehicle or its rear can be converted so that it acquires the shape and functionality of a station wagon (see FIGS. 8 to 12). A cargo box 50 for rear attachment to the vehicle contains two opposite side walls 51 and a front wall 52. The top cover 53 traverses the interior and is transparent, and is made, for example, from polycarbonate. It is possible for the top cover 53 to also be formed in one piece with the front wall 52. The side walls can likewise be formed from transparent polycarbonate or from another plastic or from metal. The floor 54 of the cargo box 50 is formed to be movable and can be moved at least partially out of its closed position so that a corresponding floor opening 55 can be cleared. The floor 54 is, for example, a louvered sliding bottom 56 with individual louvers which are pivotally joined relative to one another on their lengthwise sides which border one another. Guides for the louvered sliding bottom 56 and the louvers are mounted on the side walls. Each guide runs along the entire lower edge of the side part 51, after deflection along the front edge of the respective side part 51, and after another deflection along the top edge of the side part 51, finally back in the opposite direction. On the rear section the cargo box 50 has a cargo opening 57 which can be closed by an angled cargo box flap 58 which, for example, can be pivoted around a pivot axis on the top edge of the side walls, and thus, has both a back 59 and also a top 60 which is intended for closing the rear opening 61 behind the upper cover 53. Spring-damper elements 62 support the operation of the cargo box flap.

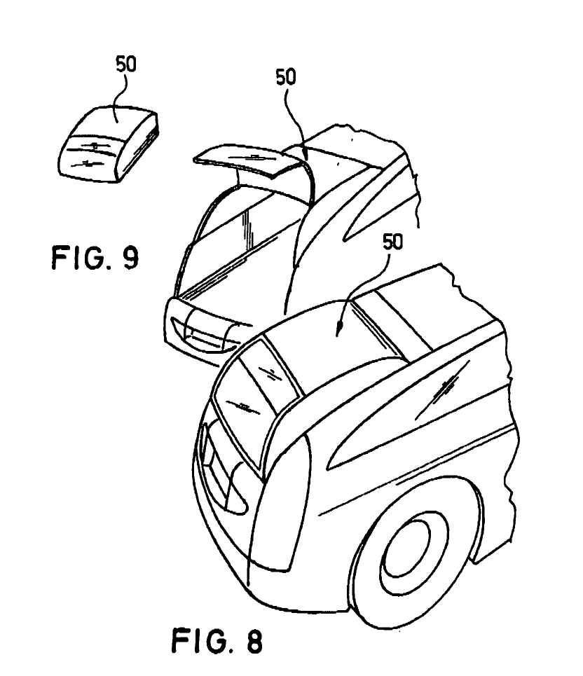

The cargo box 50 is matched in its dimensions to the holding position on the vehicle rear and can be fixed by holding means on the top edge of the body structures which border the trunk laterally. The front wall 52 is matched to the rear window and borders it so that an essentially flush transition between the vehicle body and the cargo box 50 is formed. When the cargo box 50 is mounted in the vehicle shown in FIGS. 1 to 7 or in the vehicle shown in FIGS. 8 and 9, after opening the cover 5 of the trunk 3 and after opening the louvered sliding bottom 56, a station wagon-like rear space can be used. To open the louvered sliding bottom 56, it is pushed forward by means of a rear handle 63 on the last louver. In doing so, the louvers slide along the inside of the front wall 52 and the bottom of the cover 53 into their open position (see FIG. 12). When the louvered sliding bottom 56 is closed, the cargo box 50 can be used as an additional closed cargo or trunk space which is accessible from the outside via the cargo box flap 58.

The cargo box 50 is also suited for other types of trunk covers, such as, for example, for shades which can be rolled up, for a removable cover, or the like. The cargo box flap 58 can extend farther down beyond the louvered sliding bottom 56 so that, in a modification of a motor vehicle, in which a rear hatch as shown in the figures is not used, the cargo box flap 58 can also close the rear trunk opening 6.

Here, the floor of the trunk can also be made as a sliding cargo floor, for example, in the form of a peripheral flexible structure which can be pushed by sliding on a fixed floor surface in the lengthwise direction.

Basically, in the vehicles shown, the rear hatch 7 in its lowered horizontal loading position can also be used as a load carrier, such as, for example, a bicycle carrier. For this purpose, additional holders can be attached to the rear hatch 7 and/or the rear body.

When the cover means 5 or the louvered sliding bottom 56 is opened, the trunk 3 forms an open cargo surface in the manner of a pickup or a high cargo space in the manner of a station wagon. By pivoting the rear hatch 7 down at the height of the cargo surface, the latter can be lengthened accordingly.

The cargo box can also be mounted on the roof of a motor vehicle, such as a station wagon or the like, and the rear roof section can be cleared, for example, by means of a cover which can be moved forward. Over this clearable opening, the cargo box 50 can be mounted on the roof of the motor vehicle and can be used in the described manner.

1. Motor vehicle, comprising:
a rear trunk having a trunk opening and
a cover means for alternately closing or clearing a top trunk opening,
wherein the cover means has a plurality of cover parts which are movably supported on each side of the trunk opening from a closed position into a storage position in which the cover means has been moved forward so as to clear the trunk opening.

2. Motor vehicle as claimed in claim 1, wherein at least one vehicle seat for transporting passengers is located in the trunk for use when the cover means is in the storage position.

3. Motor vehicle as claimed in claim 2, wherein the vehicle seat is movable from a position of nonuse on or in a bottom of the trunk into a position of use.

4. Motor vehicle as claimed in claim 3, wherein a roll bar is fixable in a protective position for protecting occupants of the vehicle seats.

5. Motor vehicle as claimed in claim 4, wherein the roll bar is supported for movement out of a lowered position of nonuse into the protective position.

6. Motor vehicle as claimed in claim 1, wherein the cover parts are louvers.

7. Motor vehicle as claimed in claim 1, wherein the cover parts are movably guided on lateral body-mounted rails for movement into a storage space which extends at least partially in front of the trunk.

8. Motor vehicle as claimed in claim 1, wherein the cover parts are pivotally joined together, and are disposed tightly against one another to form a flexible flat structure in the closed position.

9. Motor vehicle as claimed in claim 1, wherein the cover parts are located flat bordering one another essentially behind the back seats in the storage space.

10. Motor vehicle as claimed in claim 1, wherein the cover parts are arched in a transverse direction.

11. Motor vehicle as claimed in claim 1, further comprising a drive means for moving the cover parts.

12. Motor vehicle as claimed in claim 1, further comprising a rear hatch which is movably supported by a bearing means to close and to clear a rear loading opening of the trunk.

13. Motor vehicle as claimed in claim 12, wherein said bearing means comprises a pivoting support with a four-bar mechanism for the rear hatch.

14. Motor vehicle as claimed in claim 13, wherein the four-bar mechanism is supported on a pivoting main bearing arm which is pivotable by a drive means, and wherein the four-bar mechanism pivotable by means of its own drive.

15. Motor vehicle as claimed in claim 14, wherein the four-bar mechanism contains a rear carrier part on which the rear hatch is pivotally supported.

16. Motor vehicle as claimed in claim 15, wherein the drives are hydraulic drives.

17. Motor vehicle as claimed in claim 1, further comprising a cargo box that is mountable on the vehicle over the trunk opening.

18. Motor vehicle as claimed in claim 17, wherein the cargo box has a bottom which is openable.

19. Motor vehicle as claimed in claim 18, wherein the bottom of the cargo box is formed of louvers which are movable along inside an front wall of the cargo box into a storage position under a top of the cargo box when the bottom is opened.

20. Motor vehicle as claimed in claim 18, wherein the cargo box has a rear cargo box flap.

21. Motor vehicle as claimed in claim 18, wherein the cargo box is made at least partially from transparent polycarbonate.

22. Motor vehicle, comprising:
a vehicle body with a cargo space,
a cover means for alternately closing and clearing a cargo space opening, and
a removable cargo box having a movable bottom,
wherein the cargo box is mountable over the cargo space, and wherein the movable bottom of the cargo box is movable between a closed position in which the cargo box is separated toward the cargo space and an open position in which the cargo box is opened toward the cargo space opening so as to provide the cargo space with an increased cargo volume.

23. Motor vehicle as claimed in claim 22, wherein the bottom of the cargo box is formed of louvers which are movable along inside an front wall of the cargo box into a storage position under a top of the cargo box when the bottom is opened.

24. Motor vehicle as claimed in claim 23, wherein the cargo box has a rear cargo box flap.

25. Motor vehicle as claimed in claim 18, wherein the cargo box is made at least partially from transparent polycarbonate.
